(19) United States
(12) Patent Application Publication
(10) Pub. No.: US 2013/0103168 A1
(43) Pub. Date: Apr. 25, 2013

(54) Control Device and Method for Controlling a Movement of an Element of an Installation

(71) Applicant: Robert Bosch GmbH, Stuttgart (DE)

(72) Inventors: Frank Hielscher, Lohr Am Main (DE); Gunther May, Karlstadt (DE)

(73) Assignee: Robert Bosch GmbH, Stuttgart (DE)

(21) Appl. No.: 13/656,417

(22) Filed: Oct. 19, 2012

(30) Foreign Application Priority Data
Oct. 20, 2011 (DE) 10 2011 116 442.5

(51) Int. Cl. G06F 19/00

(52) U.S. Cl. 700/56

(57) ABSTRACT

A control device is configured to control a movement of an element of an installation and includes a main processor and an auxiliary processor. The main processor has a first computer architecture. The auxiliary processor is connected to the main processor and includes a second computer architecture. The second computer architecture differs from the first computer architecture. The second computer architecture allows faster processing of predetermined signals than the first computer architecture. The auxiliary processor is configured (i) to read in an auxiliary-processor input signal from the main processor, and (ii) to determine an auxiliary-processor output signal and to output it to the main processor by using the auxiliary-processor input signal.

This application claims priority under 35 U.S.C. §119 to patent application no. DE 10 2011 116 442.5, filed on Oct. 20, 2011 in Germany, the disclosure of which is incorporated herein by reference in its entirety.

### BACKGROUND

The present disclosure relates to a control device and a method for controlling a movement of an element of an installation.

In many automation installations, stored program controllers (SPCs) are currently used. These can be provided with a program in order to automate the most varied sequences, for instance in factory installations. Many SPC systems are combined with so-called motion functionality which makes it possible to accurately control even complex movement sequences as occur, for instance, in machine tools or in robotics. Such control programs can require very high computing powers, especially in the domain of motion. For this reason, efficient controllers or industrial PCs based on universal processors such as, for example PC main processors or microcontrollers are generally used for this purpose. The term “automation controller” is to be used here as representative of such systems. Compact controllers which combine features of PC-based control systems and stored-program controllers are called programmable automation controllers, PACs in brief.

In the field of simulation technology, graphics processors have been used for some time, for instance by PCs, for performing calculations for simulations (see, for example Marco Di Sarno: “Atomistic simulations on novel process architectures—simulations on graphics processors”, main seminar on “Modern simulation methods in physics” at Stuttgart University, 2010), in contrast to their original purpose, namely the rendering of graphics for representation on screens. In many cases, particularly if simple normal program structures are involved, the use of graphics processors can result in considerable enhancement of performance compared with the sole calculation on universal processors such as, for instance, PC main processors. Other special processors such as, for example, audio or network processors, can also be used for similar purposes.

Furthermore, dynamically configurable logic chips such as, for example, Field Programmable Gate Arrays (FPGAs) can be used to supplement universal processors. In this context, a configuration is stored in them which is specifically designed for the respective application, can also be generated dynamically and, in the case of suitable design provides for considerable acceleration in comparison to the utilization of a universal processor due to the specialization (see, for example, Gerhard Lienhart: “Acceleration of hydrodynamic astrophysical simulations and FPGA-based reconfigurable coprocessors”, dissertation at Heidelberg University, 2004).

Against this background, it is the object of the present disclosure to create an improvided control device and an improved method for controlling a movement of an element of an installation.

### SUMMARY

The present disclosure creates a control device for controlling a movement of an element of an installation, wherein the control device has the following features:
a main processor and
an auxiliary processor, wherein the auxiliary processor is connected to the main processor and has a computer architecture which differs from a computer architecture of the main processor, especially wherein the computer architecture of the auxiliary processor allows faster processing of predetermined time-variable signals than the computer architecture of the main processor and wherein the auxiliary processor is constructed for reading in an auxiliary-processor input signal from the main processor and, by using the auxiliary-processor input signal, determining an auxiliary-processor output signal and outputting it to the main processor,
   wherein the main processor is constructed for reading in an input signal, determining the auxiliary-processor input signal by using the input signal and conveying it to the auxiliary processor, reading in the auxiliary-processor output signal determined by the auxiliary processor and, by using the auxiliary-processor output signal, determining a control signal for controlling the movement of the element of the installation.

Furthermore, the present disclosure creates a method for controlling a movement of an element of an installation, wherein a control device has a main processor and an auxiliary processor, wherein the auxiliary processor is connected to the main processor and has a computer architecture which differs from a computer architecture of the main processor, especially wherein the computer architecture of the auxiliary processor provides for faster processing of predetermined time-variable signals than the computer architecture of the main processor, wherein the method has the following steps:
reading in an input signal by the main processor;
outputting an auxiliary-processor input signal by the main processor to the auxiliary processor in response to the input signal;
receiving of an auxiliary-processor output signal output by the auxiliary processor at the main processor, wherein the auxiliary processor provides the auxiliary-processor output signal in response to the auxiliary-processor input signal; and
determining a control signal for controlling the movement of the element of the installation by the main processor, wherein the control signal is provided in response to the auxiliary-processor output signal provided by the main processor.

Also of advantage is a computer program product having a program code which can be stored on a machine-readable medium such as a semiconductor memory, a hard disk memory or an optical memory and is used for performing the method according to one of the embodiments described above, when the program is executed on a computer or a device.

The present disclosure thus creates a computer program having program code for performing or actuating the steps of the above mentioned method when the computer program is executed on a control device.

An installation can be understood to be, for example, a device of automation technology such as, for example, a welding system, a conveying system or the like, in which individual elements such as, for example, a grappler with welding tongs are set in motion. A computer architecture can be understood to be an interconnection by which the individual switching elements of the relevant processors are connected to one another. For example, the computer architecture can specify an (at least partially) variable (i.e. non-permanently programmable) or fixed (i.e. permanently programmable) wiring or connection of the individual components of the processor. In this context, the computer architecture of the main processor can be optimized with respect to other parameters than the computer architecture of the auxiliary processor. Especially, the auxiliary processor can have a computer architecture which is designed for providing for faster processing of predetermined (time-variable) signals. These predetermined (time-variable) signals can be, for example, signals such as frequently occur in graphics applications or audio applications. For example, predetermined signals can be those that represent a displacement of a picture element in a predetermined direction and distance. Such a signal occurs in image processing, but also in the calculation of a movement of an element of an installation from a starting point to a destination point. In this manner, it is also possible to use, for calculating the route to be traveled by the element from the starting point to the destination point, a processor which is especially optimized for such calculations with respect to a processing speed, for example from the field of image processing with certain graphics processors.

The present disclosure is based on the finding that controlling a movement of an element of an installation can be carried out very efficiently by relocating at least a part of the numeric load in the calculation of control data for the moving element of an installation into a processor optimized or designed especially for dynamic calculation processes, namely the auxiliary processor. Such an (auxiliary) processor can be, for example, a graphics processor and/or an audio processor which processes signals for a graphics output or audio signals for output. This auxiliary processor can be supplied with higher-level information or data by a main processor so that the functionality of the auxiliary processor can be restricted essentially only to a part, i.e. certain calculation tasks in the processing of a signal processing rule for which the auxiliary processor has been especially optimized. In this manner, the special efficiency of the auxiliary processor in the field of processing dynamic signals can be used in a supporting manner, wherein the higher-level control (i.e. the determination of the control signals for the movement of an element) of the installation is provided by the main processor which is programmed in a simple and flexible manner.

The present disclosure offers the advantage that, by combining the main processor with the auxiliary processor optimized for certain functionalities, significant acceleration of the determination of the control signal of the element of the installation is possible. In this context, it is possible to access components already available so that the field of installation control, which does not represent such a large market as the field of entertainment electronics, can profit from innovations in the field of entertainment electronics, nevertheless, and said innovations can be used for improving the efficiency of the installation controllers. To this extent, additional benefit can be implemented in the technical field of installation control by utilizing technical innovations, for example, from the field of entertainment electronics.

According to one embodiment of the present disclosure, the main processor can be constructed in such a manner that a processing rule for processing signals is programmed at least partially non-permanently in the main processor and/or that the auxiliary processor is constructed in such a manner that a processing rule for processing signals is programmed at least partially permanently into the auxiliary processor. Such an embodiment of the present disclosure offers the advantage of a particularly good adjustability between a higher-level main processor unit, which can be programmed as flexibly as possible, which calculates the control signal for the movement of the element of the installation, and a particularly fast calculation of individual processing steps of the entire processing rule for determining the control signal for the movement of the element of the installation.

It is also advantageous if, according to one embodiment of the present disclosure, the main processor is constructed for loading a part of a code of a processing rule as processing rule into the auxiliary processor, wherein the auxiliary processor is constructed for determining the auxiliary-processor output signal by applying the code of the processing rule to the auxiliary-processor input signal. Such an embodiment of the present disclosure offers the advantage of good load handling by the auxiliary processor since by loading certain code, the tasks coded in the code can also be transferred from the main processor to the auxiliary processor and then no longer need to be processed by the main processor.

In order to achieve a particularly fast determination of the control signal for the movement of the element of the installation, certain processing steps can be carried out in parallel. According to one embodiment of the present disclosure, for example, at least one further auxiliary processor can be provided for this purpose, wherein the further auxiliary processor is connected to the main processor and has a computer architecture which differs from a computer architecture of the main processor, especially wherein the computer architecture of the further auxiliary processor provides for faster processing of predetermined time-variable signals than the computer architecture of the main processor and wherein the further auxiliary processor is constructed for reading in a further auxiliary-processor input signal from the main processor and/or the auxiliary processor and, by using the further auxiliary-processor input signal, determining a further auxiliary-processor output signal and outputting it to the main processor and/or the auxiliary processor, especially wherein the main processor is constructed for determining the control signal for controlling the movement of the element of the installation by using the further auxiliary-processor output signal.

According to one embodiment of the present disclosure, a processor can be particularly advantageously provided as auxiliary processor, the computer architecture of which has been optimized for processing signals for displaying graphics, processing audio data or for programming in dynamically configurable logic circuits. Using this type of processor as auxiliary processor is found to be very helpful for rapidly determining the control signal.

According to a further embodiment of the present disclosure, the main processor can also be constructed for transmitting several auxiliary-processor input signals (cyclically) offset in time to the auxiliary processor and receiving an auxiliary-processor output signal in response to each auxiliary-processor input signal transmitted to the auxiliary processor, and wherein the main processor is constructed for determining the control signal by using the auxiliary-processor output signals received by the auxiliary processor. Such an embodiment of the present disclosure offers the advantage that individual operating steps to be repeated cyclically can be executed repeatedly in the auxiliary processor during the determination of the control signal, wherein the main processor can access the particular efficiency of the auxiliary processor time and again for determining partial results (in the form of the auxiliary-processor output signals).

In order to achieve a particularly simple implementation of the control device according to one embodiment of the present disclosure, the auxiliary processor can be embedded as part-unit into an integrated circuit with the main processor. In this arrangement, a core (for example of a number of several cores) of an integrated circuit can form the main processor and another area of the integrated circuit can form the auxiliary processor. In this arrangement, both the main processor and the auxiliary processor can be arranged in a common housing of the integrated circuit.

### BRIEF DESCRIPTION OF THE DRAWINGS

In the text which follows, the disclosure will be explained in greater detail by way of example by means of the attached drawings, in which:

FIG. 1 shows a block diagram of a first exemplary embodiment of the present disclosure as control device;

FIG. 2 shows a block diagram of a second exemplary embodiment of the present disclosure as control device; and

FIG. 3 shows a flowchart of an exemplary embodiment of the present disclosure as method.

### DETAILED DESCRIPTION

In the figures following, identical or similar elements can be provided with identical or similar reference symbols. Furthermore, the figures of the drawings, their description and the claims contain numerous features in combination. In this context, it is clear to an expert that these features are also considered individually or they can be combined to form further combinations, not explicitly described here.

A first aspect, which forms the basis for the approach described here is that, for example, graphics processors can also be used for running SPC and/or motion program code, partially as a supplement to a universal processor, or wholly and autonomously. It must be assumed that applications will result in which, as a result, considerable increase in the processing speed can be achieved since typically very regular structures are found both in SPC and in motion program code which are well suited for processing on graphics processors. It is furthermore advantageous in this approach that graphics processors are frequently linked autonomously or, with respect to access priorities, preferably to the main processor, depending on the system architecture used, and do not compete with other system components for access to system busses.

Other special processors, too, such as, for example, audio processors, can be suitable for an application in the acceleration of SPC and/or motion program code.

A second aspect of the approach presented here is, for example, the utilization of dynamically configurable logic chips for accelerating the sequence of SPC and/or motion program code.

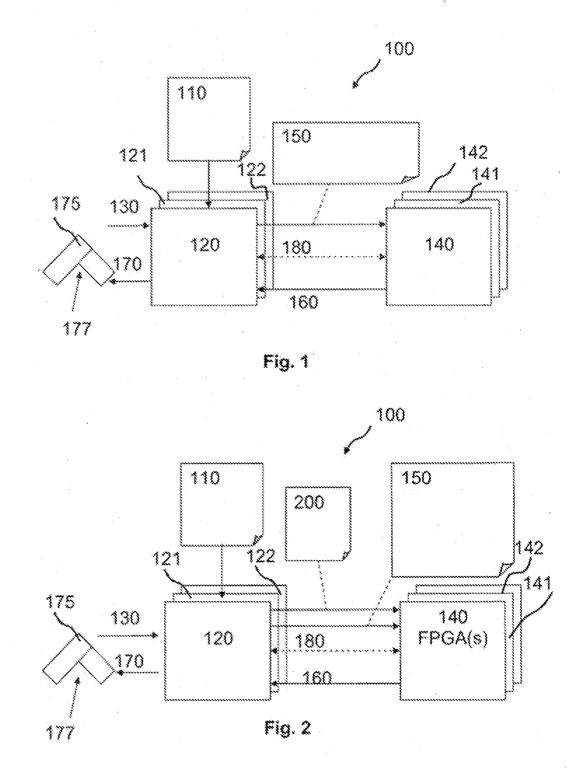

FIG. 1 shows a block diagram of a first exemplary embodiment of the present disclosure as control device 100 as a first example of implementing the present disclosure. The block diagram shown in FIG. 1 of the first example of implementation of the basic concept described shows a control device 100 in which an SPC/motion program code 110 (i.e. a program code by means of which a stored program controller is to be controlled for a movement of an element of an installation) is to be stored in one (of several) main processor(s) 120 (or 121, 122). In this context, an input signal 130 is supplied to the main processor 120 which, for example, represents a start of a program sequence to be performed in the main processor 120. Furthermore, the control device 100 comprises at least one graphics processor 140, according to the exemplary embodiment shown in FIG. 1 three graphics processors 140, 141 and 142, which operate as auxiliary processor(s) 140. In this arrangement, as a result of an auxiliary-processor input signal 150, which is output by the main processor 120 to the auxiliary processor 140, a selected proportion of a part of the SPC/motion program code edited for the graphics processor 140 is transmitted so that operations corresponding to the signal processing rule which are coded in the code transmitted in the auxiliary-processor input signal 150, are executed in the auxiliary processor 140. Furthermore, real values can also be transferred in the auxiliary-processor input signal 150 as variables which represent the basis for the calculation results determined in the auxiliary processor 140 by using the code transferred from the main processor 120 to the auxiliary processor 140. These calculation results are then transferred in an auxiliary-processor output signal 160 from the auxiliary processor 140 to the main processor 120 in which then, by using the calculation results transferred in the auxiliary-processor output signal 160, the control signal 170 for actuating the movement of the element 175 of the installation 177 is determined. The element 175 can then be, for example, a grappler of a production machine as installation 177, for example in order to apply welding seams to a workpiece by using the grappler 175. To speed up a calculation of the values of the calculation results in the auxiliary processor 140, other signals 180 can optionally also be exchanged for communication between the main processor 120 and the auxiliary processor 140, for example for synchronization of the signal communication or controlling the signal processing between the main processor 120 and auxiliary processor 140.

FIG. 1 thus shows a part of an automation controller 100 as exemplary embodiment of the present disclosure. The main processor 120 which in this case is a universal processor receives the user program, e.g. in order to control an automation process in a factory. A part of the program which is particularly suitable for processing in the graphics processor 140 may be edited into a form particularly suitable for the graphics processor 140, forwarded to the graphics processor 140 (for example by means of the signal 150). After the calculation, the graphics processor 140 delivers the results 160 back to the main processor 120. In the meantime, additional communication 180 may take place. As a rule program code is of a cyclic nature in automation technology so that this entire process or parts thereof can be repeated correspondingly.

FIG. 2 shows a block diagram of a second exemplary embodiment of the present disclosure as control device 100. In contrast with the representation from FIG. 1, however, the auxiliary processor or processors 140 are constructed as FPGA(s) (field programmable gate arrays). FIG. 2 thus shows a further example of implementation of the basic concept described. In the representation from FIG. 2, a part of an automation controller 100 is again shown. In this context, the program code to be executed on the FPGA 140 may be put into a form usable for the FPGA 140 in the present configuration. Subsequently, the FPGA or FPGAs 140 is/are configured by the main processor 120 by means of a configuration signal 200 in such a manner that they can execute the present program code or parts thereof as efficiently as possible. The configuration signal 200 thus contains logic configuration information on how the individual circuit or logic units of the FPGA 140 are to be interconnected to one another so that they can execute the operating steps to be executed by the FPGA as auxiliary processor 140 as rapidly and efficiently as possible. From then on, the further procedure (i.e. the transmission of information between the main and auxiliary processor) proceeds similarly to the exemplary embodiment which has been shown, and described in greater detail, in FIG. 1. The FPGA configuration provided via the configuration signal 200 can be static for the running time of the control device 100. As an alternative, the FPGA 140 can be reconfigured via the configuration signal 200 during the running time of the control device 100.

The present disclosure thus provides for an implementation of the SPC and motion functionality on special processors and/or FPGAs as supplement or replacement for universal processors. Important aspects of the present disclosure thus relate, for example, to the utilization of one or more auxiliary or graphics processors for accelerating, by partial execution or for exclusive execution of SPC program code, on the one hand, and motion program code, on the other hand, wherein the motion program code, which specially relates to calculation steps for movements of the elements, is executed on the especially designed auxiliary processor. A further aspect of the disclosure relates to a utilization of one or more other special processors, for instance audio processors for accelerating by partial execution or for exclusive execution of SPC program code (especially on the main processor) on the one hand, and a motion program code (especially on the auxiliary processor), on the other hand. A further aspect of the present disclosure can also be seen in that a utilization of one or more dynamically configurable logic chips such as, for instance, field programmable gate arrays (FPGAs) for the acceleration by partial execution or for exclusive execution of SPC program code, on the one hand, and a motion program code, on the other hand. At the same time, the auxiliary processor or processors, i.e. the respective additional chip or the respective additional chips (graphics/special processor or FPGA) can also be integrated wholly or partially in the main processor or processors. A further aspect of the disclosure also relates to an automatic selection (which is partially also called mapping) of the aforementioned graphics processor or processors, the other aforementioned special processor or processors, or the aforementioned dynamically configurable logic chip(s) to be accelerated. In this context, proportions of the program code are split off and written into the auxiliary processor for the calculation of the control signal by the compiler, the main processor at running time or by manual selection by the user during program generation so that the parts of the processing rule which are contained in the proportions split off are executed in the auxiliary processor.

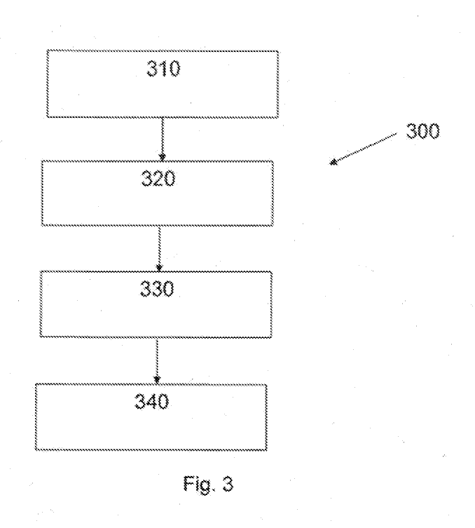

FIG. 3 shows a flowchart of an exemplary embodiment of the present disclosure as method 300 for controlling a movement of an element of an installation. The control device has a main processor and an auxiliary processor, wherein the auxiliary processor is connected to the main processor and has a computer architecture which differs from a computer architecture of the main processor, especially wherein the computer architecture of the auxiliary processor provides for faster processing of (time-variable) signals than the computer architecture of the main processor. The method also comprises a step of reading in 310 an input signal by the main processor. Furthermore, the method 300 comprises a step of outputting 320 an auxiliary-processor input signal by the main processor to the auxiliary processor in response to the input signal. Furthermore, the method 300 comprises a step of receiving 330 an auxiliary-processor output signal, output by the auxiliary processor, to the main processor, wherein the auxiliary processor has provided the auxiliary-processor output signal in response to the auxiliary-processor input signal. Finally, the method 300 comprises a step of determining 340 a control signal for controlling the movement of the element of the installation by the main processor, wherein the control signal is provided in response to the auxiliary-processor output signal provided by the auxiliary processor.

The exemplary embodiments shown are selected only by way of example and can be combined with one another.

What is claimed is:

1. A control device configured to control a movement of an element of an installation, comprising:
a main processor having a first computer architecture; and
an auxiliary processor that is connected to the main processor, and includes a second computer architecture,
wherein the second computer architecture differs from the first computer architecture,
wherein the second computer architecture of the auxiliary processor allows faster processing of predetermined signals than the first computer architecture of the main processor,
wherein the auxiliary processor is configured (i) to read in an auxiliary-processor input signal from the main processor, and (ii) by using the auxiliary-processor input signal, to determine an auxiliary-processor output signal and to output it to the main processor, and
wherein the main processor is configured (i) to read in an input signal, (ii) to determine the auxiliary-processor input signal by using the input signal and transmitting it to the auxiliary processor, (iii) to read in the auxiliary-processor output signal determined by the auxiliary processor, and (iv) by using the auxiliary-processor output signal, to determine a control signal for controlling the movement of the element of the installation.

2. The control device according to claim 1, wherein:
the main processor is configured such that a processing rule for processing signals is programmed at least partially non-permanently in the main processor, and/or
the auxiliary processor is configured such that a processing rule for processing signals is programmed at least partially permanently into the auxiliary processor.

3. The control device according to claim 1, wherein:
the main processor is configured to load a part of a code of a processing rule as processing rule into the auxiliary processor, and
the auxiliary processor is configured to determine the auxiliary-processor output signal by applying the code of the processing rule to the auxiliary-processor input signal.

4. The control device according to claim 1, further comprising:
at least one further auxiliary processor that is connected to the main processor, and includes a third computer architecture,
wherein the third computer architecture differs from the first computer architecture of the main processor,
wherein the third computer architecture of the at least one further auxiliary processor provides for faster processing of predetermined signals than the first computer architecture of the main processor,
wherein the at least one further auxiliary processor is configured (i) to read in a further auxiliary-processor input signal from the main processor and/or the auxiliary processor, and (ii) by using the further auxiliary-processor input signal, to determine a further auxiliary-processor output signal and output it to the main processor and/or the auxiliary processor, and
wherein the main processor is configured to determine the control signal for controlling the movement of the element of the installation by using the further auxiliary-processor output signal.

5. The control device according to claim 1, wherein a processor is provided as the auxiliary processor, the computer architecture of which has been optimized for processing signals for displaying graphics, processing audio data or for programming in dynamically configurable logic circuits.

6. The control device according to claim 1, wherein:
the main processor is configured (i) to transmit several auxiliary-processor input signals offset in time cyclically to the auxiliary processor and (ii) to receive an auxiliary-processor output signal in response to each auxiliary-processor input signal transmitted to the auxiliary processor, and
the main processor is configured to determine the control signal by using the auxiliary-processor output signals received by the auxiliary processor.

7. The control device according to claim 1, wherein the auxiliary processor is embedded as part-unit into an integrated circuit with the main processor.

8. The control device according to claim 1, wherein the auxiliary processor is connected to the main processor as part-unit of an electronic circuit.

9. A method of controlling a movement of an element of an installation, comprising:
reading in an input signal by a main processor;
outputting an auxiliary-processor input signal by the main processor to an auxiliary processor in response to the input signal;
receiving an auxiliary-processor output signal output by the auxiliary processor at the main processor, wherein the auxiliary processor has provided the auxiliary-processor output signal in response to the auxiliary-processor input signal; and
determining a control signal for controlling the movement of the element of the installation by the main processor, wherein the control signal is provided in response to the auxiliary-processor output signal provided by the auxiliary processor,
wherein the auxiliary processor is connected to the main processor and has a computer architecture which differs from a computer architecture of the main processor, and
wherein the computer architecture of the auxiliary processor provides for faster processing of predetermined signals than the computer architecture of the main processor.

10. The method according to claim 9, wherein:
the main processor and the auxiliary processor are included in a control device,
a computer program having program code is configured to carry out or actuate the method, and
the computer program is configured to be executed on the control device.
